(19) United States
(12) Patent Application Publication
(10) Pub. No.: US 2021/0112418 A1
(43) Pub. Date: Apr. 15, 2021

(54) SMS FRAUD DETECTION

(71) Applicant: MASTERCARD INTERNATIONAL INCORPORATED, Purchase, NY (US)

(72) Inventors: Rukuma VIEGAS, Pune (IN); Rajesh Pralhadrao MAHALLE, Pune (IN)

(21) Appl. No.: 16/599,571

(22) Filed: Oct. 11, 2019

(51) Int. Cl. H04W 12/12; G06N 20/00; G06N 5/04; H04L 29/06; H04W 12/00

(52) U.S. Cl. CPC H04W 12/1208; G06N 20/00; H04W 12/00506; H04L 63/101; G06N 5/04

(57) ABSTRACT

A method for SMS fraud detection can begin at an SMS gateway and include receiving a message for transmittal via SMS for a recipient; assigning a fraud score to the message; appending, to the message, a trust indicator based on the fraud score; and sending the message with the trust indicator to the recipient via SMS. Assigning a fraud score can include checking a link included in the message and/or checking content in the message itself, and then calculating a fraud score based on the link and/or content of the message.

### BACKGROUND

Short message service (SMS) refers to a text messaging service that enables users to send and receive messages. SMS is used in mobile marketing. SMS marketing enables subscribers to opt-in to promotional messages from a company. The promotional messages can include information about upcoming events, discounts, and even support customer engagement. SMS marketing (also referred to as application-to-peer messaging) can also be used to deliver targeted service messages such as parcel-delivery alerts, real-time notification of credit/debit card purchase confirmations to protect against fraud, one-time passcode delivery, and appointment confirmations.

With the ability to send mass texts from an application to subscribers, scammers may use these channels to commit fraud, including by incorporating malware into SMS messages. For example, texts can be sent that appear to a recipient as coming from their bank, but instead of containing links to a legitimate app store for downloading an app for that bank, the links are to a spoofed page or contain malicious code.

### BRIEF SUMMARY

SMS fraud detection is provided. An SMS gateway with SMS fraud detection can be used to provide additional security for senders of application-to-peer messaging. A fraud score of a message sent via SMS can be calculated based on the message and appended to the message before the message is sent to the recipient. This can alert the recipient to potential risk of a received message that might otherwise seem legitimate.

A method for SMS fraud detection can begin at an SMS gateway with receiving a message for transmittal via SMS for a recipient. The method can continue with assigning a fraud score to the message; appending, to the message, a trust indicator based on the fraud score; and sending the message with the trust indicator to the recipient via SMS.

Assigning a fraud score can include checking a link included in the message and calculating a fraud score based on the link. Assigning a fraud score can further include checking content in the message. In such a case, the fraud score can be calculated based on the link and any checked content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a scenario of SMS fraud.

FIGS. 2A and 2B illustrate example user interfaces of a scenario of SMS fraud.

FIG. 3 illustrates an example operating environment for SMS fraud detection.

FIG. 4 illustrates a method for SMS fraud detection.

FIG. 5 illustrates an example scenario incorporating a method for SMS fraud detection.

FIG. 6 illustrates an example fraud score determination.

FIG. 7A-7C illustrate example fraud score indicators.

FIG. 8 illustrates components of a computing system that may provide an SMS Gateway Service as described herein.

FIG. 9A is a simplified block diagram of an example SMS gateway server.

FIG. 9B is a simplified block diagram of an example SMS marketing device.

FIG. 9C is a simplified block diagram of a recipient device.

### DETAILED DESCRIPTION

SMS fraud detection is provided. An SMS gateway with SMS fraud detection can be used to provide additional security for senders of application-to-peer messaging. A fraud score of a message sent via SMS can be calculated based on the message and appended to the message before the message is sent to the recipient. This can alert the recipient to potential risk of a received message that might otherwise seem legitimate.

An SMS gateway can work in conjunction with a website or application to allow a computer to send or receive SMS transmissions to or from a telecommunications network so that messages can more easily be sent over a variety of communication protocols. Enterprises using SMS marketing channels and recipients of those messages have a need for confidence that messages are genuine. With the possibility of malicious access (e.g., via hacking) to companies' customer information, including contact information, having SMS fraud detection in the transmission path from company to customer can put both the company and the customer at ease. Indeed, recipients of an SMS marketing message can be provided with an extra layer of security that they will not be subject to SMS fraud. As mentioned above, SMS fraud can include scenarios where links are included in an SMS message that look like they are to a legitimate app store for downloading an app for a particular business, the links are to a spoofed page or contain malicious code.

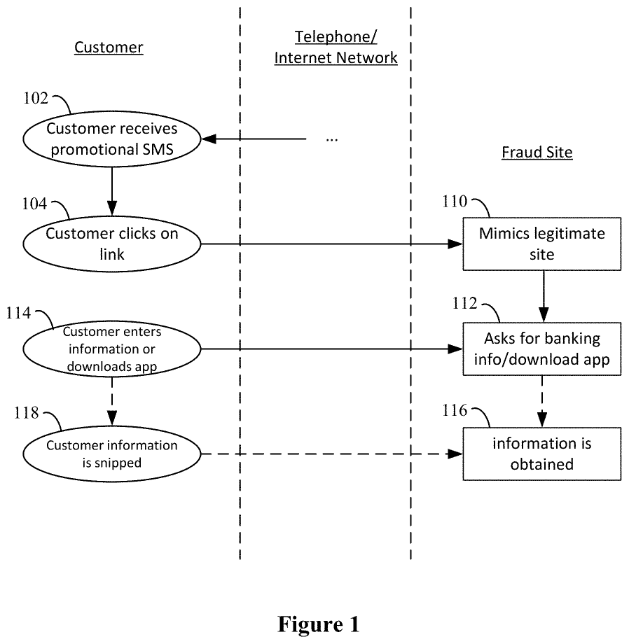

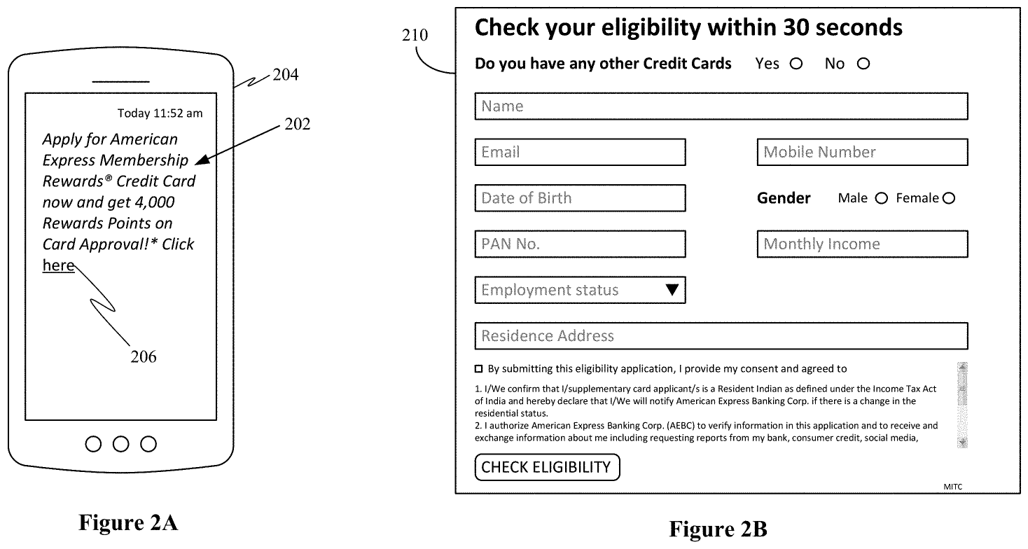

FIG. 1 illustrates a scenario of SMS fraud; and FIGS. 2A and 2B illustrate example user interfaces of a scenario of SMS fraud. Referring to FIG. 1, the SMS fraud scenario begins when a customer has received (102) what appears to be a legitimate promotional SMS message (either a promotion or a one-time password) from a merchant or issuer bank. In the illustrated scenario, the SMS contains a link. For example, referring to FIG. 2A, a recipient can receive a message 202 on a personal computing device 204 such as a mobile phone. In this example, the message 202 includes a link 206. Of course, messages may include text, images, and even attachments. The message 202 can appear to be from a legitimate source, such as an issuer bank or merchant, but, due to the result of an attack on the source, may be directed by a malicious source. The message 202 can thus appear legitimate in all regards, including a phone number or identification. Consequently, a recipient may be more open to a fraudulent attack

Returning to FIG. 1, if the customer follows that link, for example by clicking (104) on the link, the customer will arrive at a fraud site 110. The site 110 can be configured to appear legitimate—the site may contain graphics, formatting, and even a URL close to the site that the fraud site is attempting to mimic. The fraud site can request (112) banking or personal information or attempt to get the customer to download an app. For example, referring to FIG. 2B, after selecting the link, the recipient may be directed to a webpage 210 managed by a fraudulent entity. Like the message 202 described with respect to FIG. 2A, the webpage 210 may appear legitimate. In the illustrated scenario, the webpage 210 offers a reward for completing a survey including personal information. The recipient may trust the website in part due to the legitimate appearance of the SMS and have personal information given to an attacker.

Returning to FIG. 1, a customer may enter (114) information or download an app. When the customer inputs this information or downloads the app, information, including financial information, can be stolen by the fraud site (e.g., site obtains (116) information). For example, in the scenario shown in FIG. 2B, the personal and financial information that customer may have entered in the webpage 210 may be received directly by a malicious party and used to make fraudulent charges. In some cases, the clicking on a link or command at the fraud site causes malware to be downloaded and run at the customer's device, resulting in the customer's information being snipped (118) and transmitted to the malicious party.

These scenarios can be addressed by an SMS gateway with SMS fraud detection such as described herein.

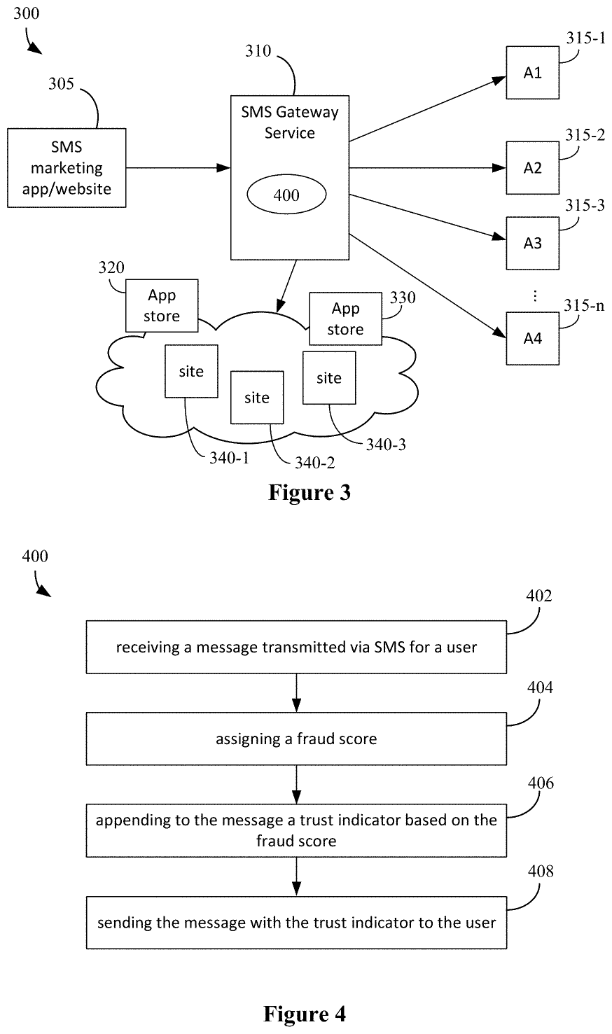

FIG. 3 illustrates an example operating environment for SMS fraud detection. Referring to FIG. 3, an operating environment 300 for SMS fraud detection can include an SMS marketing application or website 305 that an entity uses for generating SMS marketing messages; an SMS gateway service 310, which can perform method 400 for SMS fraud detection such as described with respect to FIG. 4; and a plurality of recipient devices (e.g., devices 315-1, 315-2, 315-3, . . . 315-n). The SMS gateway service 310 can be used to provide additional security for senders of application-to-peer messaging. Also included in the operating environment 300 are the app stores (e.g., app store 320 and app store 330) and websites/webpages (e.g., 340-1, 340-2, 340-3) that may be linked to in the messages sent from the SMS marketing app/website 305.

FIG. 4 illustrates a method for SMS fraud detection. The method 400 may begin by receiving (402) a message for transmittal via SMS for a recipient. The message can be sent by a first party such as an issuer bank or a merchant site to reach a recipient. The message may also be sent by a fraudulent entity who has attacked a legitimate entity such as an issuer bank or a merchant site. The described method can be used to determine whether the message is from the fraudulent entity. An SMS gateway service, such as service 310 of FIG. 3, can receive the message directly or via an intermediary system. After receiving the message, a fraud score can be assigned (404) to the message. In some cases, the fraud score can be assigned by checking a link included in the message and calculating a fraud score based on the link. In some cases, the fraud score can be assigned by checking the content in the message and calculating the fraud score based on the content of the message. In some cases, the fraud score can be assigned by checking the link included in the message and the content of the message and then calculating the fraud score based on both the link and the content of the message.

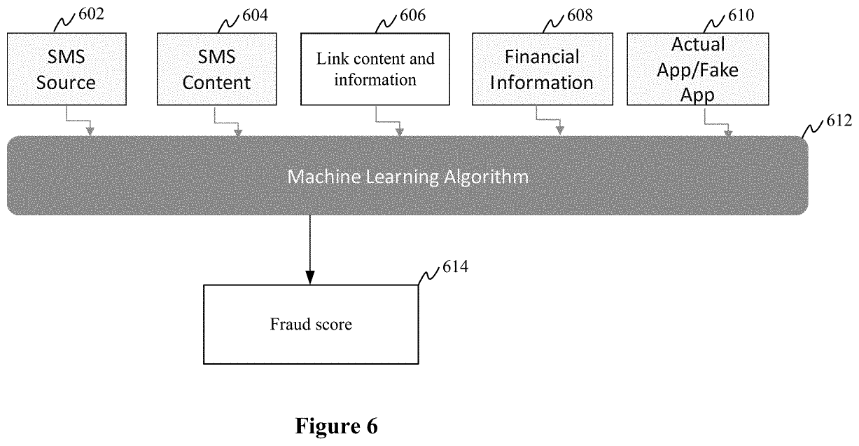

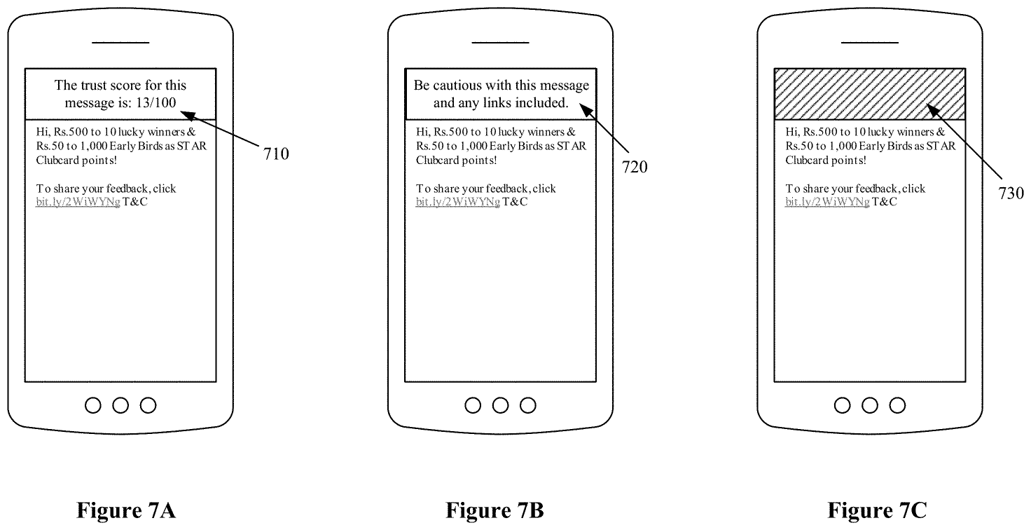

The fraud score can be based on aspects of the message, including content in the message and content associated with a link in the message. The content can be scanned and input into a machine learning algorithm, such as a neural network, to check for indicators or patterns in the content that are indicative of fraud such as typos or requests for personal information. The link can be followed via a crawler, which can extract content, tags, and other information from the website for analysis. In some cases, a link can be checked by comparing the link to a whitelist or a blacklist. An example fraud score determination using these elements is described with respect to FIG. 6. A trust indicator based on the fraud score can be appended (406) to the message. The trust indicator can have a variety of implementations, including a numeric score, a string (e.g. a suggestion from the system on whether the message is fraudulent), or a color. The trust indicator can be embedded as metadata in the message or simply added on as additional content. FIGS. 7A-7C illustrate examples of a trust indicator. The message with the trust indicator can then be sent (408) to the recipient via SMS. The trust indicator can be automatically shown as part of the message at the user device or shown after a particular user input.

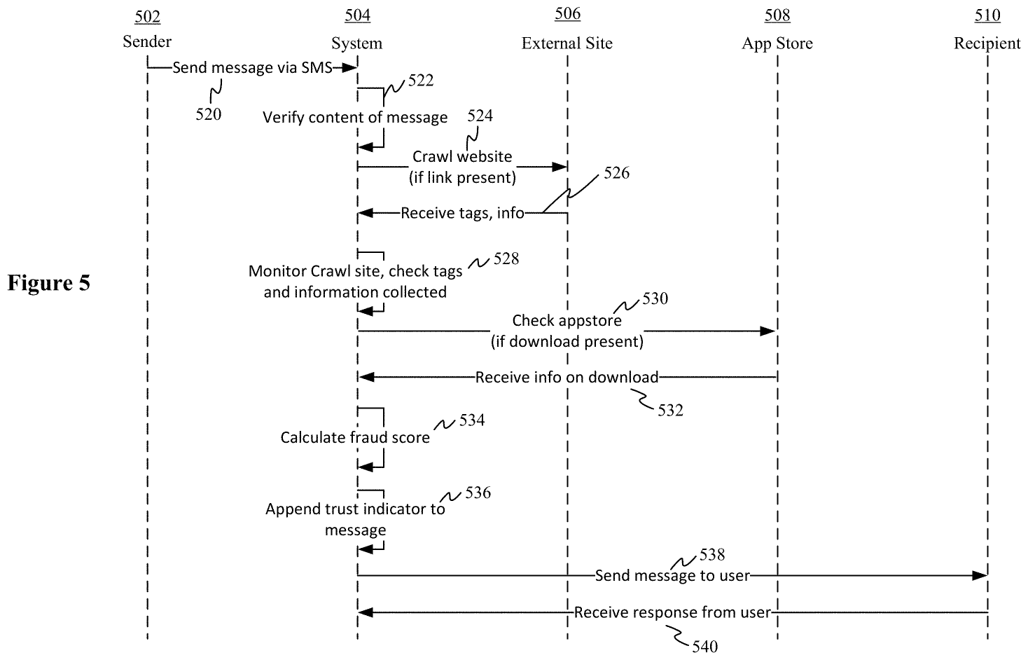

FIG. 5 illustrates an example scenario incorporating a method for SMS fraud detection. In the illustrated scenario, the environment can include a sender 502, a system 504, an external site 506, an app store 508, and a recipient 510. The sender 502 can be an issuer bank or merchant. The system can be a fraud detection system and may be a part of an intermediary, such as an SMS notification gateway (and provided as an SMS gateway service). The external site 506 may be the destination of a link provided in the message and may be a legitimate site managed by an issuer bank or merchant or may be an illegitimate site managed by an illegitimate entity. The app store 508 can be a repository of applications, such as the Google Play store or the iTunes store. The recipient 510 can be the intended recipient of the message.

The process can begin with the system 504 receiving (520) a message for a recipient 510 from a sender 502. The system 504 may receive the message directly or be forwarded the message or content of the message by another intermediary. The message can be an SMS message and include SMS content and a mobile number to which SMS needs to send. The process can continue with verifying (522) the content of the message. The text of the message can be scanned and input into a neural network or other machine learning system to determine likelihood of the content being fraudulent (see e.g., FIG. 6). For example, typos may indicate that a message is fraudulent. Alternatively, the content can be scanned for keywords, perhaps involving requests for personal information. An output of the neural network or other machine learning system can be a fraud score based on the content. A result can also be compiled and stored to later create a fraud score.

The process can also check any links in the message. To do so, the system may use a crawler to crawl (524) an external site 506 that has a link in the message. Content, tags, and other information (e.g. a Universal Resource Locator (URL)) can be gathered (526) from the external site 506 and analyzed (528). In some cases, where the content of the site includes requests for financial information, a higher level of scrutiny may be applied. The content of the external site 506 can be analyzed using a neural network or other machine learning system to determine likelihood of the content being fraudulent (see e.g., FIG. 6). For example, typos may indicate that a message is fraudulent. Alternatively, the content can be scanned for keywords, including terms and phrases involving requests for personal information. The tags can also be scanned to determine if personal information is being requested, which may indicate fraudulent activity. Other information, such as URLs, can also influence a trust score. For instance, a URL provided in the message that is close to an official website's URL may be indicative of fraud (e.g. a URL being one letter off of a banking website). The fraud score can be updated based on the content, tags, and other information from the external site 506. Alternatively, results can be compiled and stored to later create a fraud score.

If downloads (e.g., files or an application that is available for download) or download links are present in either the message or on the external site 506, the downloads can be examined. If the application downloads are hosted on an app store 508, the download links can be followed (530) and information from the app store 508 can be received (532). If the application that is linked is not hosted by the company associated with the sender number, the fraud score can be modified. If the download is a direct download, the fraud score can also be modified.

It should be noted that the processes of checking content, checking the links, and checking the app store 508 can be performed in any suitable order and even in parallel, depending on implementation.

The process can continue with the fraud score being fully calculated (534). If the fraud score is calculated at the end of each part (e.g. after verifying the content and checking the links), then the fraud score can be finalized. If the results are compiled for later, the system 504 can now use the results to calculate the fraud score. A trust indicator can be formed once the fraud score is calculated. The trust indicator can have a variety of implementations, including a numeric score, a string (e.g. a suggestion from the system on whether the message is fraudulent), or a color. The trust indicator can then be appended (536) to the message. The message can then be sent (538) to the recipient 510.

The system can be configured to receive a response from the recipient. When the message is displayed at the recipient's computing device, a menu may be surfaced alongside the trust indicator. The menu can be used to determine a response of the recipient to the message. In some embodiments, the menu can be a simple question asking if the message is trusted. The response can be received by the system (540). In some embodiments, if the recipient indicates that the message is not trusted, the message may be suppressed. In some embodiments, if the recipient indicates that the message is not trusted, the recipient may also receive an option to report the message to a regulatory body, such as the Fraud Database or Federal Communications Commission. The response of the recipient can also be used for feedback in the system. In some cases, a feedback option can be appended to the message by the SMS gateway service along with the trust indicator in order to support the return of feedback to the SMS gateway service. If machine learning or neural networks are used in the process, the message and response (e.g. trustworthy or not trustworthy) can be used as a training set.

FIG. 6 illustrates an example fraud score determination. A machine learning algorithm 612 can take a number of inputs from a SMS message in order to evaluate these inputs. These inputs can include a source of the message for transmittal (e.g., source of the SMS) 602, content of the message 604, including the content presentation (e.g. typos or language associated with scams) and whether financial information is requested, content and other information from links in the content 606 (including financial information requests 608), and the legitimacy of any applications that are linked to in the message or link 610. For each time any of the inputs are present, the fraud score 614 can be modified. If a higher fraud score 614 indicates that the site is more likely to be a fraud site, for instance, the score can increase with the presence and frequency of the inputs. The inputs may have different weights—for instance, a fraudulent application download present in the message or in a link provided by the message may increase the fraud score 614 more than a less formal message.

In some cases, the source of the message for transmittal 602 can indicate whether there is a likelihood of fraud. The source information can include, but is not limited to, IP addresses, SMS marketing application identifier, issuer or merchant name or identifier, sender phone number. Some sources may be considered more trustworthy, while other sources may have had previous fraud or a likelihood of spoofing or hacking or even a known breach. In some cases, the machine learning algorithm can determine whether the SMS source is a valid issuer or merchant (as verified against the issuer identifier or merchant identifier). If the SMS source is considered a valid issuer or merchant, a point may be added to the score.

In some cases, the content of the message 604 can indicate whether there is a likelihood of fraud. The content presentation may have patterns, including misspellings, and/or may include a request for personal information or financial data. In some cases, if the content does not ask for personal information or financial data, a point may be added to the score.

In some cases, the links 606 can indicate whether there is a likelihood of fraud. The indication of fraud may be from how the link looks as well as the content referenced by the link. For example, shortened URLs, number-based links, look-alikes, and hyphens may have a higher risk of fraud. In some cases, if the URL tag or PII (personally identifiable information) or PCI (payment card information) data is being collected by the site, the score may be reduced by a point.

In some cases, financial information requests 608 at a site referenced by a link can indicate whether there is a likelihood of fraud. In some cases, if financial information is requested from a site, the score may be reduced by a point.

In some cases, the applications that are linked to in the message or link 610 can indicate whether there is a likelihood of fraud. For example, in some cases, if a downloadable link suggests applications to download, the system can check in an app store whether the application is registered with a valid source (e.g., valid issuer or merchant); and if not registered with a valid source (or just a non-registered source), the score may be reduced by a point.

The total score may be based on the remaining points after evaluating each input to the machine learning algorithm.

FIG. 7A-7C illustrate example fraud score indicators. The trust indicator can be automatically displayed when a recipient views the message. Alternatively, the trust indicator may only be displayed after receiving a particular user input, such as a long touch. In some cases, the trust indicator can be provided alongside the message. In some cases, the trust indicator is provided over the message. Placement can be a matter of design choice and message constraints.

Referring to FIG. 7A, the trust indicator can be displayed as a numeric value 710. The numeric value can be the fraud score directly displayed, or the numeric value may be modified (e.g. normalized to a 100-point scale or to a less even distribution). A low value may indicate low confidence in the legitimacy or a high value may indicate low confidence in the legitimacy, depending on implementation. The number can be displayed without context or with context to give the recipient a sense of scale (e.g. as shown in the picture, giving the 7100′ to give a sense of scale).

Referring to FIG. 7B, the trust indicator may be displayed as a string 720 (e.g. a suggestion from the system on whether the message is fraudulent). There may be two possible messages (e.g. variants of “this is trusted” and “this is not trusted) or there may be more than two levels of warnings. Different ranges of fraud scores could result in the same messages (e.g. for a particular sender which is attacked frequently, a lower fraud score could be required to send a caution that the message is not trusted).

Referring to FIG. 7C, a color indicator 730 may be used as the trust indicator. For example, certain colors may be used (e.g. red indicates that a link is likely fraudulent, yellow suggests caution, green indicates that the message is likely legitimate).

In some cases, a pattern or non-numeric symbol (e.g., a flag) can be used to visually indicate a level of trust.

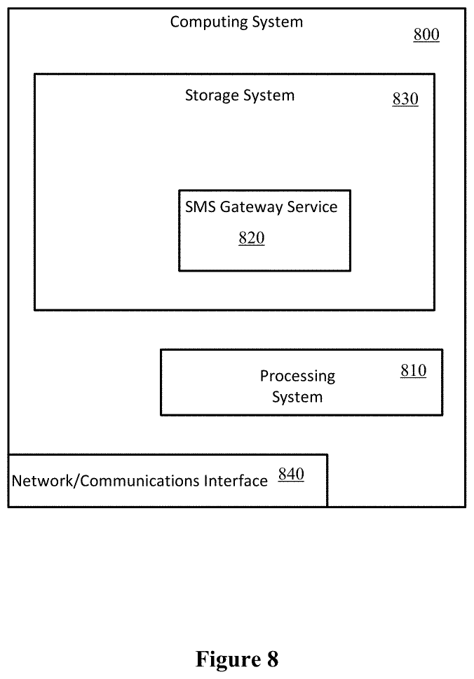

FIG. 8 illustrates components of a computing system that may provide an SMS Gateway Service as described herein. Referring to FIG. 8, system 800 may be implemented within a single computing device or distributed across multiple computing devices or sub-systems that cooperate in executing program instructions. The system 800 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 800 can include a processing system 810, which may include one or more processors and/or other circuitry that retrieves and executes software for an SMS Gateway service 820 from storage system 830. Processing system 810 may be implemented within a single processing device but may also be distributed across multiple processing devices or sub-systems that cooperate in executing program instructions.

Storage system(s) 830 can include any computer readable storage media readable by processing system 810 and capable of storing software for the SMS Gateway service 820. Storage system 830 may be implemented as a single storage device but may also be implemented across multiple storage devices or sub-systems co-located or distributed relative to each other. Storage system 830 may include additional elements, such as a controller, capable of communicating with processing system 810. Storage system 830 may also include storage devices and/or sub-systems on which data is stored.

Software for the SMS Gateway service 820, including routines for performing method 400 such as described in FIG. 4 and processes performed by system 504 of FIG. 5 may be implemented in program instructions and among other functions may, when executed by system 800 in general or processing system 810 in particular, direct the system 800 or processing system 810 to operate as described herein.

Communication interface 840 may be included, providing communication connections and devices that allow for communication between system 800 and other computing systems (not shown) over a communication network or collection of networks (not shown) or the air.

In embodiments where the system 800 includes multiple computing devices, the system 800 can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

In some embodiments, system 800 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

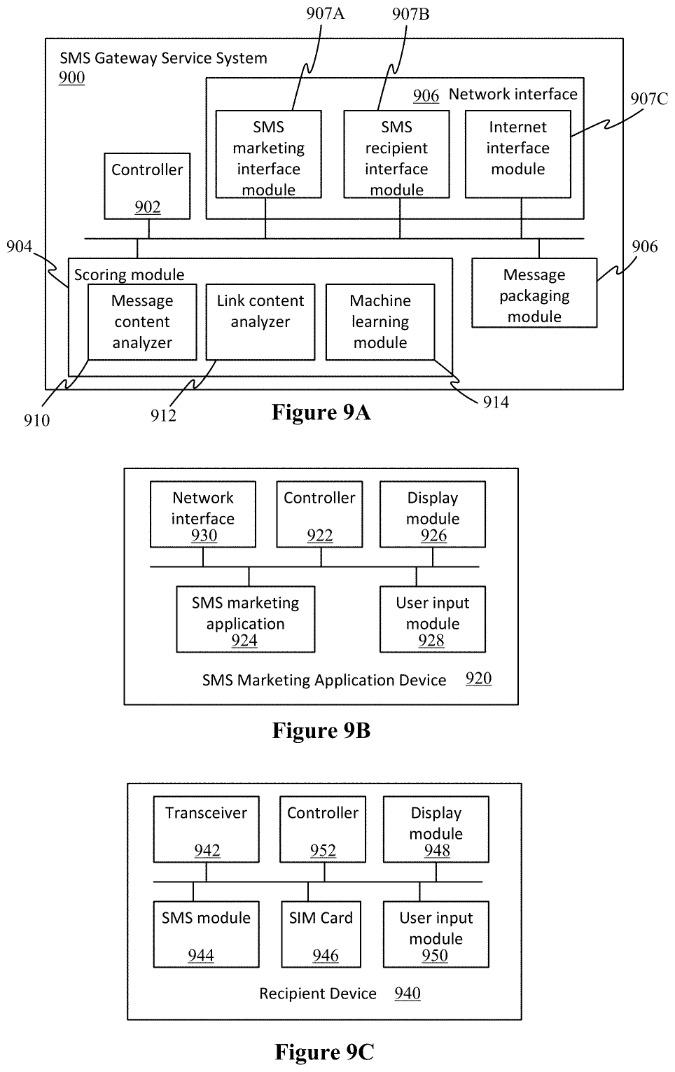

FIG. 9A is a simplified block diagram of an example SMS gateway server. SMS gateway server 900 may be configured to execute process 400 described with respect to FIG. 4 and can provide SMS gateway service 310 as illustrated in FIG. 3 and described with respect to SMS gateway service 820 of FIG. 8. SMS gateway server 900 includes at least one controller 902 for executing instructions. The controller 902 can be any suitable processor such as those described with respect to processing system 810 of FIG. 8. The instructions may be stored in memory and/or as part of independent modules (which may be software, hardware, or a combination of software and hardware), and can include instructions and/or hardware for the SMS gateway service 310 as illustrated in FIG. 3 and described with respect to SMS gateway service 820 of FIG. 8. The modules can include a scoring module 904 and a message packaging module 906, and can be communicably coupled to controller 902.

The controller 902 may be communicably coupled with network interface 908 such that SMS gateway server 900 is enabled for communication with any electronic device having network communication capabilities (e.g., any entity connected to a network). Network interface 908 can include or support actions directed by SMS marketing interface module 907A, SMS recipient interface module 907B, and Internet interface module 907C.

SMS marketing interface module 907A supports communications with, for example, SMS marketing app/website 305 as shown in FIG. 3, and can be used to receive a message transmitted via SMS from, for example, an SMS marketing app/website, for a user (see e.g., operation 520 of FIG. 5). SMS marketing interface module 907A may support messages received, for example, via SMSC protocols (e.g., SMPP, CIMD) or an HTTP/HTTPS interface.

SMS recipient interface module 907B supports communications with, for example, any one or more of recipient devices 315-1, 315-2, 315-3, . . . 315-n as shown in FIG. 3, and can be used to send a message with a trust indicator to a specified user's recipient device after a fraud score is determined. SMS recipient interface module 907B may support sending of messages, for example, via the various SMSC protocols, mobile phone protocols, GSM/GPRS modem protocols, and the like.

Internet interface module 907C supports communications with, for example, servers hosting app store 320 and app store 330 and servers hosting web sites/webpages 340-1, 340-2, 340-3, as shown in FIG. 3. Internet interface module 907C can facilitate the crawling of external sites linked to in the received message and the gathering of the information from these external sites (see e.g., operations 524, 526 of FIG. 5). Internet interface module 907C can facilitate the following of download links and obtaining of information from app stores (see e.g., operations 530, 532 of FIG. 5).

The scoring module 904 can be used to assign a fraud score to the message received via the SMS marketing interface module 907A; and the message packaging module 906 can append a trust indicator to the message based on the fraud score. The scoring module 904 can include a message content analyzer 910 and a link content analyzer 912. In some cases, a machine learning module 914 can be included as part of the scoring module 904 to support one or more machine learning algorithms, such as the machine learning algorithm 612 described with respect to FIG. 6. A source analyzer (not shown) may further be included to analyze (alone or in conjunction with machine learning module 914) the source of the message.

The message content analyzer 910 can be used to verify content of the message itself. In some cases, the message content analyzer 910 can work in conjunction with the machine learning module 914 to determine the likelihood of the content being fraudulent. The message content analyzer 910 may be used to evaluate the text of the message for keywords, misspellings, and other elements.

The link content analyzer 912 can be used to analyze the content, tags, and other information gathered from the external site referenced by the link as obtained via Internet interface module 907C. References to financial information requests in the content at the link may be separately analyzed.

The results of the various analyses can be used by the scoring module 904 to calculate a fraud score.

The message packaging module 906 can be used to modify the SMS message being sent to recipients such that any visual indicators for the fraud score and any feedback requests or mechanisms can be appended to the message sent to the recipients via the SMS recipient interface module 907B.

FIG. 9B is a simplified block diagram of an example SMS marketing device. SMS marketing device 920 provides an SMS marketing application or website. In some cases, SMS marketing device 920 may be embodied as a computing device such as, but not limited to, a personal computer, a mobile device, a laptop, a tablet, or a server. SMS marketing device 920 includes

SMS marketing device 920 includes at least one controller 922 for executing instructions. The controller 922 can be any suitable processor such as those described with respect to processing system 810 of FIG. 8. The instructions may be stored in memory and can include instructions for an SMS marketing application 924 and/or a web browser that can be used to access a website for SMS marketing. A user of the SMS Marketing application device 920 can view the graphical user interface of the SMS marketing application 924 under control of a display module 926 and can input content for the SMS message according to input received by the user input module 928. The content of the SMS message itself may be created using any suitable content creation application (and in some cases may be created using the SMS marketing application 924).

The controller 922 may be communicably coupled with network interface 930 such that SMS marketing device 920 is enabled for communication with an SMS gateway service such as SMS gateway service 310 as illustrated in FIG. 3 and described with respect to SMS gateway service 820 of FIG. 8 in order for the user of the SMS marketing application 924 or website to send SMS messages to a plurality of recipients and have fraud detection applied as described herein. The network interface 930 can communicate with the SMS gateway service using SMSC protocols such as SMPP and CIMD or an HTTP/HTTPS interface as examples.

FIG. 9C is a simplified block diagram of a recipient device. Recipient device 940 may be an implementation of any of the recipient devices 315-1, 315-2, 315-3, . . . 315-n illustrated in FIG. 3. Recipient device 940 can be any suitable mobile device such as a mobile phone, smart watch, or other mobile computing device that includes a transceiver 942, SMS module 944, a subscriber identity module (SIM) card 946, a display module 948, a user input module 950 and a controller 952.

The transceiver 942 receives and sends communications, including SMS messages. The SMS module 944 that handles SMS messages for the mobile device and which may be incorporated in or in communication with a messaging application of the mobile device. The SMS module 944 can receive SMS messages via the transceiver 942 according to an appropriate network protocol (e.g., SMSC protocol, AT commands, etc.).

The SIM card 946 provides the information that identifies the mobile device to a network operator and may store SMS messages. The SMS module 944 communicates with the SIM card 946 to obtain information stored at the SIM card 946 and store information, such as the received SMS messages, on the SIM card 946.

The display module 948 supports the rendering and display of content, such as from received SMS messages, to a display of the mobile device. For example, display module 948 supports the rendering of graphical user interfaces such as illustrated in FIGS. 2A and 2B and 7A-7C.

The user input module 950 receives and interprets user input, such as audio input from a microphone and touch input from a touch screen display, to provide resulting information to appropriate modules or applications, including to enable viewing and feedback with respect to the received SMS messages with fraud detection. Feedback can be communicated back to an SMS gateway via the transceiver 942.

The controller 952 execute instructions and software associated with any operations described herein that is carried out at the recipient device 940. In some cases, the various modules have their own controllers and processors to perform certain of their processes. In some cases, these modules contain software that is executed by controller 952.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for SMS fraud detection, the method comprising:
receiving a message for transmittal via SMS for a recipient;
assigning a fraud score to the message;
appending, to the message, a trust indicator based on the fraud score; and
sending the message with the trust indicator to the recipient via SMS.

2. The method of claim 1, wherein assigning a fraud score comprises:
checking a link included in the message; and
calculating the fraud score based on the link.

3. The method of claim 2, further comprising:
checking content in the message;
wherein the fraud score is calculated based on the link and any checked content.

4. The method of claim 3, wherein checking the content comprises using a machine learning algorithm to identify patterns in the content that are indicative of fraud.

5. The method of claim 2, wherein checking the link comprises:
accessing a webpage referenced by the link; and
analyzing content of the webpage.

6. The method of claim 2, wherein checking the link comprises:
comparing the link to a whitelist or a blacklist.

7. The method of claim 1, wherein the trust indicator is included as metadata in the message.

8. The method of claim 1, wherein the trust indicator is a numeric value.

9. The method of claim 1, wherein the trust indicator is a string.

10. The method of claim 1, wherein the trust indicator comprises a color.

11. The method of claim 1, further comprising:
appending a feedback option to the message; and
receiving feedback via the feedback option from the recipient.

12. The method of claim 11, further comprising:
using the received feedback and the message in to train a machine learning algorithm.

13. A system for providing SMS fraud protection, comprising:
a processing system;
a storage system; and
instructions for an SMS gateway service stored on the storage system that, when executed by the processing system, direct the system for providing SMS fraud protection to at least:
receive a message for transmittal via SMS for a recipient;
assign a fraud score to the message;
append, to the message, a trust indicator based on the fraud score; and
send the message with the trust indicator to the recipient via SMS.

14. The system of claim 13, wherein the instructions to assign the fraud score direct the system for providing SMS fraud protection to:
check a link included in the message; and
calculate the fraud score based on the link.

15. The system of claim 14, wherein the instructions to assign the fraud score direct the system for providing SMS fraud protection to further:
check content in the message;
wherein the fraud score is calculated based on the link and any checked content.

16. The system of claim 15, wherein the instructions to check the link included in the message and check the content in the message directs the system for providing SMS fraud protection to use a machine learning algorithm to identify patterns that are indicative of fraud.

17. The system of claim 16, wherein the machine learning algorithm evaluates a source of the message for transmittal, the content in the message, content associated with the link, any requests for financial information in the content associated with the link, an application available for download at the link, or a combination thereof.

18. One or more computer-readable storage media having instructions for an SMS gateway service stored thereon that, when executed by a computing system, direct the computing system to at least:
receive a message for transmittal from an issuer or merchant via SMS for a customer, wherein the message comprises a promotion, a request for financial information, or payment information;
assign a fraud score to the message;
append, to the message, a trust indicator based on the fraud score; and
send the message with the trust indicator to the customer via SMS.

19. The one or more computer-readable storage media of claim 18, wherein the instructions to assign the fraud score direct the computing system to:
check a source of the message, the instructions to check the source of the message comprising determining whether the source is a valid issuer or merchant; and
calculate the fraud score based on the source.

20. The one or more computer-readable storage media of claim 19, wherein the instructions to assign the fraud score direct the computing system to:
check any link included in the message;
check content of the message;
wherein the fraud score is further calculated based on any checked link and the content.
